(19) United States
(12) Patent Application Publication
(10) Pub. No.: US 2013/0273275 A1
(43) Pub. Date: Oct. 17, 2013

(54) SHELL STRUCTURE

(71) Applicants: Shun-Chi Yang, Taipei City (TW); Hsiang-Yin Ho, Keelung City (TW); Yu-Juei Chang, New Taipei City (TW)

(72) Inventors: Shun-Chi Yang, Taipei City (TW); Hsiang-Yin Ho, Keelung City (TW); Yu-Juei Chang, New Taipei City (TW)

(21) Appl. No.: 13/607,777

(22) Filed: Sep. 9, 2012

(30) Foreign Application Priority Data
Apr. 12, 2012 (TW) 101112964

(51) Int. Cl. B32B 1/02

(52) U.S. Cl. 428/34.5; 428/36.1; 428/35.9

(57) ABSTRACT

A shell structure includes a first fiber polymer composite material layer, a second fiber polymer composite material layer, and a heat dissipating layer interposed between the first fiber polymer composite material layer and the second fiber polymer composite material layer.

### BACKGROUND OF THE DISCLOSURE

1. Technical Field

The present disclosure relates to a shell structure. More particularly, the present disclosure relates to a carbon fiber shell with improved heat dissipation performance.

2. Description of the Prior Art

As known in the art, the shell structures of electronic products are commonly constructed by aluminum-magnesium alloys, engineering plastic such as ABS, or carbon fiber fabric. As the carbon fiber shells with high strength, lightweight, flexibility, anti-radiation, UV resistance and other characteristics, together with special woven appearance and color, even although the price is relatively high, the applied products are still fashionable on the market.

In addition to shell's features of protection, and its cooling effect, thickness and weight are key points as well. Due to congenital structural characteristics of carbon fiber, resulting in its thermal anisotropy that is perpendicular to the carbon fiber orientation, poor heat dissipation effect (as opposed to the cooling effect of the parallel orientation of the carbon fiber), therefore, limiting the cooling capacity of the carbon fiber shell. This is currently the problem the industry desperately wants to improve.

### SUMMARY

It is one objective of the present disclosure to provide a high-performance shell structure that is capable of effectively dissipating heat in order to solve the above-mentioned prior art problems or shortcomings.

In accordance with one aspect of this disclosure, a shell structure includes a first fiber polymer composite material layer; a second fiber polymer composite material layer; and a heat dissipating layer interposed between the first fiber polymer composite material layer and the second fiber polymer composite material layer.

In accordance with another aspect of this disclosure, a shell structure includes a heat dissipating layer comprising a first side and a second side that is opposite to the first side; n layers of fiber polymer composite material laminated on the first side; and m layers of fiber polymer composite material laminated on the second side, wherein n and m are both an integer greater than zero.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the disclosure, and are incorporated in and constitute a part of this specification. The drawings illustrate embodiments thereof and, together with the description, serve to explain the principles hereof In the drawings:

FIG. 1 is a schematic top view of a shell structure in accordance with one embodiment;

FIG. 2A is a sectional view taken along line I-I′ in FIG. 1;

FIG. 2B is a sectional view of a shell structure in accordance with another embodiment;

FIG. 3 is a top view of a shell structure in accordance with still another embodiment; and

FIG. 4 is a sectional view of a shell structure lb in accordance with yet another embodiment.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description, reference is made to the accompanying drawings, which form a part hereof, and in which is shown by way of illustration specific examples in which the embodiments may be practiced. These embodiments are described in sufficient detail to enable those skilled in the art to practice them, and it is to be understood that other embodiments may be utilized and that structural, logical and electrical changes may be made without departing from the described embodiments. The following detailed description is, therefore, not to be taken in a limiting sense, and the included embodiments are defined by the appended claims.

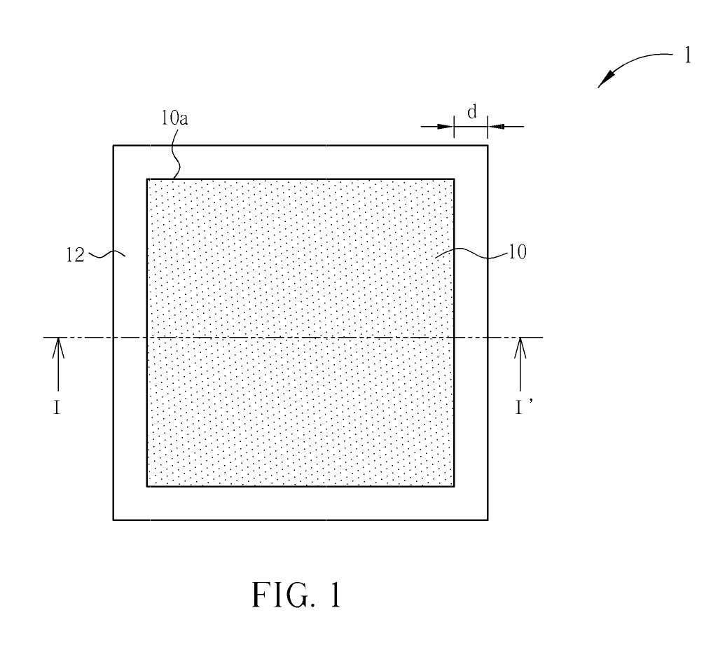

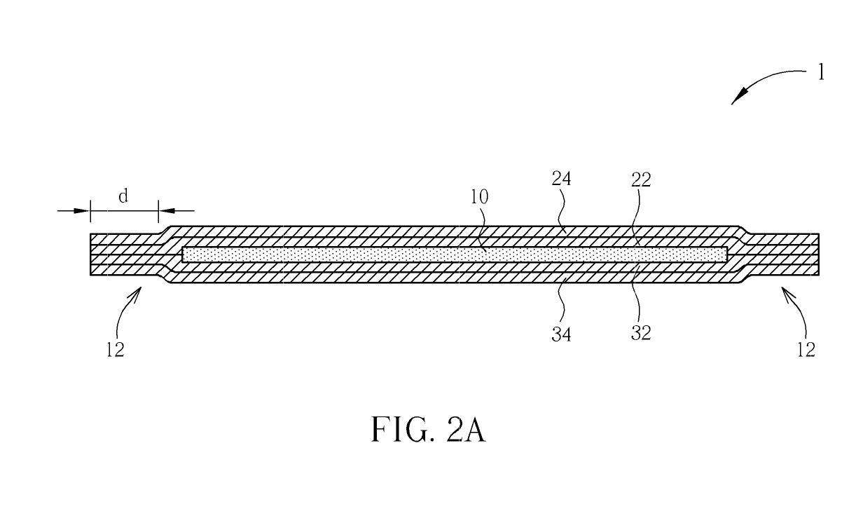

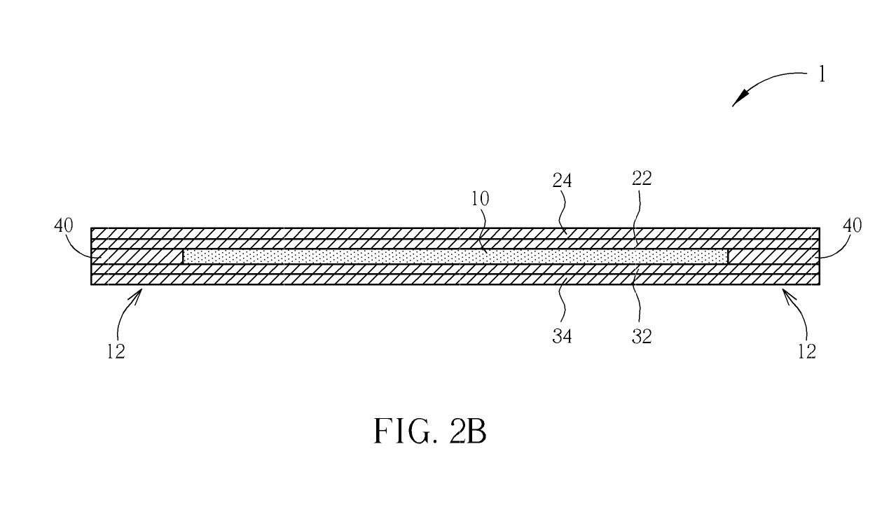

Please refer to FIG. 1 and FIG. 2A. FIG. 1 is a schematic top view of a shell structure in accordance with one embodiment thereof. FIG. 2A is a sectional view taken along line I-I′ in FIG. 1. As shown in FIG. 1 and FIG. 2A, the shell structure 1 may comprise a first fiber polymer composite material layer 22, a second fiber polymer composite material layer 32, and a heat dissipating layer 10 interposed between the first fiber polymer composite material layer 22 and the second fiber polymer composite material layer 32. According to the embodiment, both of the first fiber polymer composite material layer 22 and the second fiber polymer composite material layer 32 are in direct contact with the heat dissipating layer 10. According to the embodiment, both of the first fiber polymer composite material layer 22 and the second fiber polymer composite material layer 32 may comprise carbon fiber or glass fiber.

According to the embodiment, the first fiber polymer composite material layer 22 and the second fiber polymer composite material layer 32 are made of the same material, for example, unidirectional (UD) carbon fiber fabric. In another embodiment, the first fiber polymer composite material layer 22 and the second fiber polymer composite material layer 32 may be made of the different materials. The unidirectional carbon fiber fabric or cloth is a thin, one-directional weave of carbon pre-impregnated in epoxy resin, unsaturated polyester resin, vinyl resin, or phenolic resin matrix. According to the embodiment, the aforesaid heat dissipating layer 10 has a thermal conductivity greater than 50 W/(m·K). According to the embodiment, the heat dissipating layer 10 may comprise any heat-dissipating materials with high thermal conductivity greater than 50 W/(m·K), for example, copper, aluminum, graphite, or carbon nanosphere. In another embodiment, with high thermal conductivity greater than 50 W/(m·K), the heat dissipating layer 10 consists of at least one of copper, aluminum, graphite, and carbon nanosphere. According to the embodiment, the heat dissipating layer 10 may be an aluminum foil having a thickness of less than 0.1 mm.

According to the embodiment, the shell structure 1 may further comprise a first decorative film 24 laminated on the first fiber polymer composite material layer 22, and a second decorative film 34 laminated on the second fiber polymer composite material layer 32. For example, in accordance with the embodiment, the first decorative film 24 and the second decorative film 34 may be 3K woven carbon fiber fabric or cloth, and may have a thickness of about 0.2 mm, but not limited thereto. According to the embodiment, the shell structure 1 is formed by (1) laminating the heat dissipating layer 10, the first fiber polymer composite material layer 22, the second fiber polymer composite material layer 32, the first decorative film 24 and the second decorative film 34; (2) thermal pressing the film stack; (3) molding and/or shaping the film stack; and (4) subjecting the film stack to surface finish treatment such as polishing, painting, etc.

According to the embodiment, the heat dissipating layer 10 has an outline that is substantially conformed to the outline of the shell structure 1. Preferably, the periphery of the heat dissipating layer 10 is inwardly pulled back a predetermined distance d, wherein the predetermined distance d may range between 1-15 mm, for example, 10 mm, such that the heat dissipating layer 10 can be completely embraced and cannot be seen or easily conceived from the exterior of the structure. According to the embodiment, the first fiber polymer composite material layer 22 is in direct with the second fiber polymer composite material layer 32 within the peripheral region 12, thereby increasing the bonding strength and avoiding delamination. Since the heat dissipating layer 10 is inwardly withdrawn, the thickness of the shell structure 1 is thinner at the peripheral region 12 and slightly thicker in the center portion.

FIG. 2B is a sectional view of a shell structure in accordance with another embodiment. Optionally, as shown in FIG. 2B, an additional frame-like carbon fiber layer 40 having an aperture for accommodating the heat dissipating layer 10 is disposed in the peripheral region 12. The frame-like carbon fiber layer 40 may avoid gap or void in the laminate structure. The structure shown in FIG. 2B is particularly suited for a thicker heat dissipating layer 10.

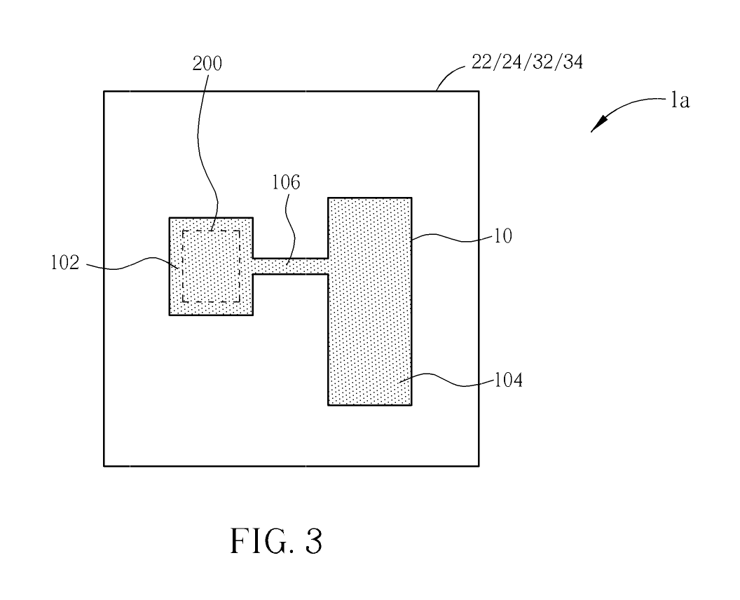

FIG. 3 is a perspective top view of a shell structure 1 a in accordance with another embodiment. As shown in FIG. 3, the embedded heat dissipating layer 10 may have an irregular outline or pattern. For example, the heat dissipating layer 10 may have a first portion 102, a second portion 104 and a connecting portion 106 that connects the first portion 102 with the second portion 104. Likewise, shell structure 1 a is a laminate structure comprising the heat dissipating layer 10, the first fiber polymer composite material layer 22, the second fiber polymer composite material layer 32, the first decorative film 24 and the second decorative film 34. Preferably, according to this embodiment, the first portion 102 is disposed directly under or above a heat-generating device or electronic heat source 200. The second portion 104 may have a surface area that is larger than the first portion 102 in order to effectively dissipate the heat and reduce the temperature of the heat source 200.

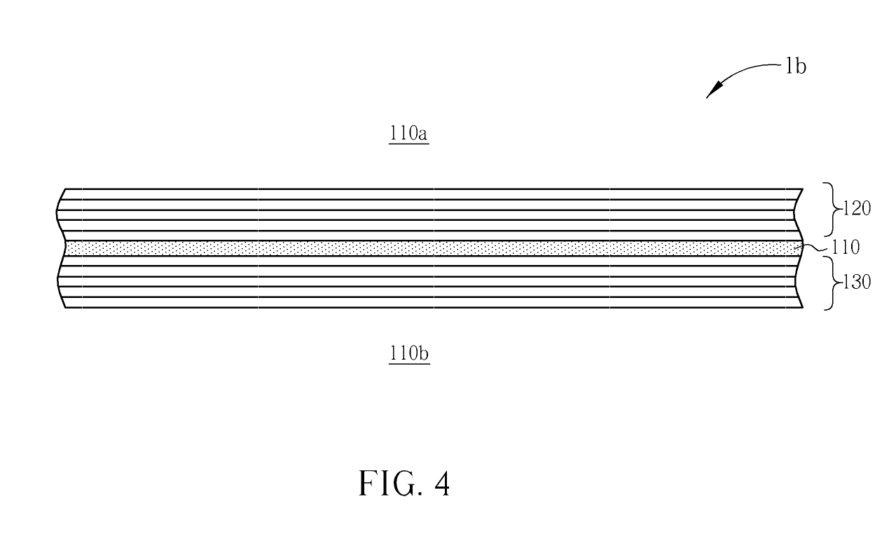

FIG. 4 is a sectional view of a shell structure lb in accordance with yet another embodiment. As shown in FIG. 4, the shell structure lb includes a heat dissipating layer 110 having a first side 110a and a second side 110b that is opposite to the first side 110a, wherein the first side 110a is closer to a heat source (not shown) than the second side 110b. The heat dissipating layer 110 may comprise copper, aluminum, graphite or carbon nanosphere, and may have a thickness of not smaller than 0.1 mm. According to this embodiment, n layers of fiber polymer composite material 120 are laminate on the first side 110a of the heat dissipating layer 110, and m layers of fiber polymer composite material 130 are laminate on the second side 110b of the heat dissipating layer 110, wherein n and m are both an integer greater than zero. The fiber polymer composite material layers 120 and 130 may comprise carbon fiber or glass fiber. According to this embodiment, n is smaller than m, such that the heat dissipating layer 110 is closer to the heat source on the first side 110a and that the heat can be removed rapidly. Of course, in other cases, n may equal to or not equal to m, depending upon the design requirements.

Those skilled in the art will readily observe that numerous modifications and alterations of the device and method may be made while retaining the teachings of the disclosure. Accordingly, the above disclosure should be construed as limited only by the metes and bounds of the appended claims.

1. A shell structure, comprising:
a first fiber polymer composite material layer;
a second fiber polymer composite material layer; and
a heat dissipating layer interposed between the first fiber polymer composite material layer and the second fiber polymer composite material layer, wherein, along periphery of the heat dissipating layer, the first fiber polymer composite material layer is in direct contact with the second fiber polymer composite material layer.

2. The shell structure according to claim 1 wherein the first fiber polymer composite material layer comprises carbon fiber or glass fiber.

3. The shell structure according to claim 1 wherein the second fiber polymer composite material layer comprises carbon fiber or glass fiber.

4. The shell structure according to claim 1 wherein thermal conductivity of the heat dissipating layer is greater than 50 W/(m·K).

5. The shell structure according to claim 4 wherein the heat dissipating layer comprises copper, aluminum, graphite, or carbon nanosphere.

6. The shell structure according to claim 4 wherein the heat dissipating layer consists of at least one of copper, aluminum, graphite, and carbon nanosphere.

7. The shell structure according to claim 1 wherein the first fiber polymer composite material layer is a unidirectional carbon fiber fabric.

8. The shell structure according to claim 7 wherein the second fiber polymer composite material layer is a unidirectional carbon fiber fabric.

9. The shell structure according to claim 1 wherein the first fiber polymer composite material layer is in direct contact with the heat dissipating layer.

10. The shell structure according to claim 1 wherein the second fiber polymer composite material layer is in direct contact with the heat dissipating layer.

11. (canceled)

12. The shell structure according to claim 1 wherein the heat dissipating layer has a thickness of less than or equal to 0.1 mm.

13. A shell structure, comprising:
a heat dissipating layer comprising a first side and a second side that is opposite to the first side;
n layers of fiber polymer composite material laminated on the first side; and
m layers of fiber polymer composite material laminated on the second side, wherein n and m are both an integer greater than zero, wherein, along a periphery of the heat dissipating layer, the first fiber polymer composite material layer is in direct contact with the second fiber polymer composite material layer.

14. The shell structure according to claim 13 wherein the fiber polymer composite material comprises carbon fiber or glass fiber.

15. The shell structure according to claim 13 wherein the heat dissipating layer has a thermal conductivity that is greater than 50 W/(m·K).

16. The shell structure according to claim 15 wherein the heat dissipating layer comprises copper, aluminum, graphite, or carbon nanosphere.

17. The shell structure according to claim 15 wherein the heat dissipating layer consists of at least one of copper, aluminum, graphite, and carbon nanosphere.

18. The shell structure according to claim 13 wherein the heat dissipating layer has a thickness of less than or equal to 0.1 mm.

19. The shell structure according to claim 13 wherein the n is equal to m.

20. The shell structure according to claim 13 wherein the n is not equal to m.

21. The shell structure according to claim 13 wherein n is smaller than m.

22. A shell structure for dissipating an electronic device with a heat source, comprising:
a first fiber polymer composite material layer;
a second fiber polymer composite material layer; and
a heat dissipating layer interposed between the first fiber polymer composite material layer and the second fiber polymer composite material layer, wherein the heat dissipating layer has a first portion, a second portion, and a connecting portion that connects the first portion with the second portion, and wherein the first portion is disposed directly under or above the heat source of the electronic device.

23. The shell structure for dissipating an electronic device with a heat source according to claim 22 wherein the second portion has a surface area that is larger than the first portion.
